(19) United States
(12) Patent Application Publication
(10) Pub. No.: US 2012/0037574 A1
(43) Pub. Date: Feb. 16, 2012

(54) WATER TREATMENT REACTOR AERATION SUPPORT

(76) Inventors: Jack Collie Gardiner, Houston, TX (US); Gerald Seidl, Houston, TX (US); Stephen A. Smith, Houston, TX (US)

(21) Appl. No.: 13/202,306

(22) PCT Filed: Feb. 17, 2010
(86) PCT No.: PCT/US10/24417

§ 371 Date: Oct. 31, 2011

Related U.S. Application Data
(60) Provisional application No. 61/154,239, filed on Feb. 20, 2009.

(51) Int. Cl. B01D 21/24; C02F 3/02; C02F 11/00; C02F 1/74

(52) U.S. Cl. 210/803; 210/220

(57) ABSTRACT

A wastewater treatment includes an elevated aeration system. The aeration system is used to provide air and nutrients to biological growth in a wastewater treatment vessel, and to promote circulation of the support media used for the biological growth. The aeration system is elevated from the bottom of the reactor vessel by supports that extend from sidewalls of the vessel, or from suspension systems that hang the aeration system at a desired height. Silt, debris and sludge may be removed from the free space between the elevated aeration system and the vessel floor. Mechanical collection or removal devices may be positioned between the elevated aeration system and the reactor floor.

### CROSS-REFERENCE TO RELATED APPLICATIONS

This application is a Nonprovisional Patent Application of U.S. Provisional Patent Application No. 61/154,239, entitled “Water Treatment Reactor Aeration Support”, filed Feb. 20, 2009, which is herein incorporated by reference in its entirety.

### BACKGROUND OF THE INVENTION

The present invention relates generally to the field of wastewater treatment systems. More particularly, the invention relates to techniques for supporting aeration systems such that reactor vessels can be easily cleaned and serviced.

In the field of wastewater treatment, a number of different system types are known and are currently in use. In general, these may consist of primary treatment, secondary treatment, and, where desired, tertiary treatment. Primary treatment is often limited to filtering and sludge removal. Secondary treatment may include a wide range of processes, such as biochemical oxygen demand reduction, nitrification, denitrification, and so forth. Following secondary treatment, further settling, filtering, polishing and other operations may be performed before the wastewater is advanced to a final application.

In a number of the processes used for wastewater treatment, particulate matter may be caused to precipitate from the wastewater and collect on the bottom of a vessel. Reactor vessels for secondary treatment, for example, commonly hold a bolus of wastewater in a reactor vessel, along with biological support media. The biological support media may include various shapes and configurations of synthetic plastic elements on which bacteria or other microbes are allowed to grow and through which wastewater can pass. The bacteria proliferate and serve to treat the water in the reactor vessel by circulation of the water over the support media. To promote the growth and sustenance of the microbial growth, moreover, such reactor vessels may have aeration systems that bubble fresh air through the wastewater, feeding the bacteria and causing the media to move so as to adequately circulate the wastewater over the growth.

In known wastewater treatment vessels of this type, it is common to form aeration systems of one or more headers from which distribution conduits extend. Air is provided through the header, and travels through the distribution conduits and out through holes formed in the distribution conduits. The air can thus bubble through the water to aid in mixing the water and moving the biological growth support media. Similar systems may be provided for pulsing air time-to-time for similar purposes. Such aeration systems, however, are commonly supported on the bottom of the reactor vessels. That is, risers and various supports may be provided that raise the header and distribution conduits slightly from the bottom of the vessel. These support systems, however, may preclude cleaning of the reactor vessels. The vessels are, therefore, from time-to-time emptied, and the aeration systems must be removed to access and manually remove sludge, debris, and grit from the bottom of the vessels.

There is a need, however, for improved systems for wastewater reactor vessel maintenance. More particularly, there is a need for techniques that can allow for effective aeration of reactor vessels, while allowing for continuous or periodic cleaning, or at least simplified cleaning on an as-needed basis.

### BRIEF DESCRIPTION OF THE INVENTION

The present invention provides a wastewater treatment reactor aeration support system and method designed to respond to such needs. The system may be installed in any type of wastewater treatment reactor, but is particularly well-suited to reactors in which the aeration system may be lowered and secured in place on supports provided within the reactor. The supports may extend from the reactor wall, and serve to support the entire aeration system at a distance above the vessel floor. A space between the aeration system and the vessel floor, then, is unencumbered. The space may be provided with an automated, or semi-automated cleaning system for the removal of accumulated sludge, debris, grit, and so forth. Alternatively, the bottom region of the vessel between the aeration system and the vessel floor may be unencumbered, and sludge may be easily removed by systems that are passed between the aeration system and the floor from time-to-time.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 a diagrammatical representation of a wastewater treatment system including a pair of reactors and aeration systems spaced from the floors of the reactors;

FIG. 2 is a perspective view of an aeration system supported in a wastewater treatment reactor in accordance with aspects of the invention;

FIG. 3 is a somewhat more detailed view of a portion of the aeration system of FIG. 2, illustrating an exemplary technique for supporting the aeration system in the reactor vessel;

FIG. 4 is a diagrammatical representation of an aeration system supported above the floor of the reactor, with the floor being angled to promote the accumulation and the removal of sludge, debris, and grit;

FIG. 5 is a similar diagrammatical representation of a wastewater treatment reactor in which a continuous chain and scraper system is provided for the removal of sludge, debris, and grit; and

FIG. 6 is a similar representation of a reactor vessel in which a space below the aeration system is completely unencumbered, allowing for sludge, debris, and grit cleanout by vacuum systems, and so forth.

### DETAILED DESCRIPTION OF THE INVENTION

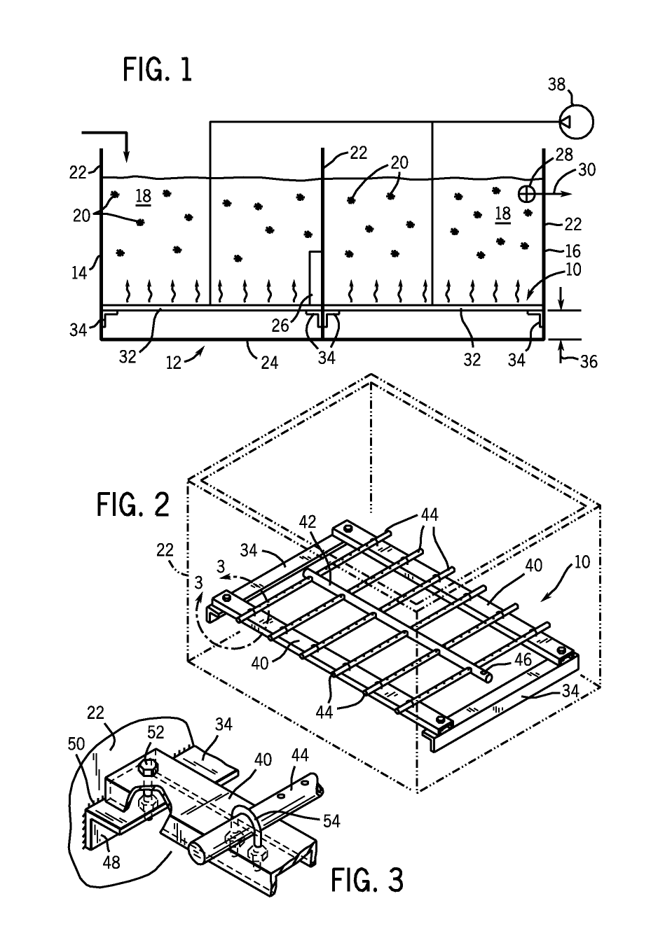

Turning now to the drawings, and referring first to FIG. 1, a diagrammatical representation is shown of an elevated aeration system 10 in a wastewater treatment system 12. The wastewater treatment system 12, in this case, is a part of a secondary wastewater treatment system in which treatment reactors 14 and 16 receive wastewater 18 for such processes as biochemical oxygen demand reduction and nitrification. The wastewater may have been processed by certain primary wastewater treatment equipment, such as for silt and sludge removal, such as via strainers and filters. In general, the wastewater will be introduced into the first reactor vessel 14, and advanced to the second reactor vessel 16 after some residence time in the first reactor vessel. The mass flow rates of the wastewater are designed to provide sufficient time for treatment in each reactor vessel. More reactor vessels may be included in the secondary wastewater treatment process, or as few as a single vessel. Moreover, multiple reactor vessels may be provided for any particular reaction performed.

As will be appreciated by those skilled in the art, wastewater treatment in vessels of this type may proceed through a range of specific processes, typically with one process being performed in each reactor vessel. For example, a vessel may be provided for biochemical oxygen demand reduction operations (BOD), nitrification operations, denitrification operations, and so forth. In such operations, a biological growth support media, indicated generally by reference numeral 20 in FIG. 1, is provided in each reactor vessel to support biological growth (e.g., bacteria) that aid in treating the wastewater. In presently contemplated embodiments, for example, the media include extruded thermoplastic matrices with surfaces that support biological growth, and openings through which wastewater may flow to promote its treatment and to provide the alimentary requirements of the biological material.

The reactor vessels 14 and 16 have sidewalls 22 and a bottom 24 that enclose the interior volume in which the wastewater is disposed, along with the biological support media. The reactor vessels may be made of concrete, metal, plastic or any suitable material. The bottom is typically sealed to the sides to form a water-tight recipient that may be open at an upper end. One or more screens, as indicated by reference numeral 26 in FIG. 1, is disposed between the reactor vessels to allow wastewater to flow from vessel 14 into vessel 16. Where the system includes additional vessels, similar screens, piping, pumps, or other components may be provided to direct water from one vessel into another, to allow the free flow of water from one vessel into another, and so forth. Depending upon the reactor vessel design and the anticipated flow rates, a plurality of screens may be provided, and these may be at various levels within the reactor, but typically below the lower-most water level anticipated during operation. Similarly, in the downstream vessel, an extraction screen 28 is provided through which effluent 30 is drawn. Here again, a number of such screens may be provided, depending upon the vessel design and the anticipated flow rates. The effluent may be advanced to other wastewater treatment operations, such as tertiary treatment. Screens 26 and 28 allow for the flow of wastewater from one reactor or process to another, while preventing the biological support media from exiting the individual reactors.

The aeration system 10 within each reactor includes a conduit system 32. As described more fully below, the conduit system may include one or more headers from which distribution tubes extend. Thus, air may be introduced into the wastewater within each reactor through the conduit system. The introduced air bubbles through the water, gradually rising and providing air for promoting the growth of the biological material on the support media. Moreover, the air aids in circulating the water and support media, further promoting the treatment.

As shown in FIG. 1, and as discussed more fully below, in the illustrated embodiment, the conduit system 32 is supported by a plurality of supports 34 extending from the sides of the vessel. Several such supports are illustrated in FIG. 1. The elevated aeration system 10 rests upon these supports such that it is spaced from the bottom or floor 24 of each vessel by a distance indicated by reference numeral 36. In any particular application, the distance may vary depending upon the space desired between the floor and the aeration system, with this space typically varying between approximately 25 and 62 cm. The conduit systems 32 receive air from a blower 38. A single blower may be provided, or a separate blower may be provided for each reactor vessel. Moreover, as will be appreciated by those skilled in the art, valving may be included for manual or remote operation, allowing the flow of air to be metered, or interrupted as desired.

FIG. 2 illustrates an exemplary embodiment of the elevated aeration system 10, shown in a surrounding wastewater treatment reactor vessel. The aeration system includes longitudinal supports 40 that physically support and hold the conduit system used to distribute air in the reactor vessel. The conduit system itself includes a header 42 and distribution tubes 44 that extend from the header. The air to be introduced into vessel is communicated to an interior volume of the header by means of an inlet connection 46. From the header, the air may be communicated to the distribution tubes from which it exits through a series of apertures (not shown in FIG. 2) formed in the distribution tubes. In variations of the arrangement, more than one header may be provided, and any sufficient number of distribution tubes may coupled to the one or more headers.

FIG. 3 is a somewhat more detailed view of an exemplary implementation of the arrangement of FIG. 2. In particular, the longitudinal support 40 illustrated in FIG. 3 is a channel-profiled support member, such as rolled steel. Moreover, in the embodiment illustrated in FIG. 3, the support 34 extends from the sidewall 22 of the reactor vessel and comprises an angle bracket, such as rolled steel. The angle bracket may be affixed to the vessel wall in any suitable manner, such as via a weldment 50 when the sidewall is made of weldable metal. As will be appreciated by those skilled in the art, where other reactor vessel materials are used, various other attachment and support arrangements may be envisaged, such as anchor bolts extending from concrete sidewalls, plates or shelves extending from concrete or plastic sidewalls, continuous or spaced brackets and shelves partially embedded in the side walls, and so forth. Similarly, various other longitudinal supports may be employed, such as angle profiles, tubing, and so forth.

In the illustrated embodiment, the longitudinal support is affixed to the angle bracket 48 by means of one or more bolts 52. The bolts firmly secure the aeration system to the supports, and prevent movement of the aeration system longitudinally and laterally. Similarly, one or more brackets, bolts, or similar structures serves to secure the conduit system to the longitudinal supports. In the embodiment illustrated in FIG. 3, for example, a U-bolt 54 is used to secure the distribution tubes 44 to the longitudinal support 40. In practice, and depending upon such factors as the size of the vessel, the types of longitudinal supports employed, the number of distribution tubes employed, and the weight of the elevated aeration system, the conduit system may be tied to the supports, as illustrated, or may be positioned above or below the supports, or both. Moreover, the entire structure may be fabricated in situ, or may be prefabricated and lowered into the reactor vessel prior to startup of the process.

It should also be noted that other physical support systems may be envisaged to raise the aeration system from the bottom of the reactor vessel. For example, a superstructure may be provided at or near the top of the vessel and the aeration system may be hung from the structure so as to position the aeration system at a desired level within the reactor vessel (spaced from the vessel floor). In such embodiments, the upper support structure may be generally similar to that illustrated, with one or more longitudinal supports, but may also include lateral supports extending between the longitudinal supports. From these, then, elongated suspension rods or hangers may be extended to the conduit system, which itself may or may not include additional support structures.

The elevation of the aeration system 10 above the bottom of the reactor vessels greatly facilitates the free accumulation of silt, sludge, debris, grit, and any other objects that may fall into or collect in the vessel during operation. Moreover, the creation of a free space along the bottom of the reactor vessel allows for such silt, sludge, debris, and grit to be more easily directed towards collection devices, or moved along or extracted by collection systems.

Moreover, while the support structures described above extend from sidewalls of the reactor vessel, or provide support by suspension of the elevated aeration system, other supports may be provided very near or even adjacent to the sidewalls and may extend to the bottom of the reactor vessel. For example, risers or elevators may be positioned adjacent to sidewalls of the vessel, while leaving an open area beneath the overall aeration system structure. The supports may be generally similar to those used in conventional wastewater treatment systems, but with no supports being provided under the portion of the aeration system spaced from the sidewalls any significant degree. Thus, access to and cleaning of silt, sludge, debris, and grit is facilitated greatly as compared to heretofore known systems that include a number of supports or risers distributed along the entire conduit system.

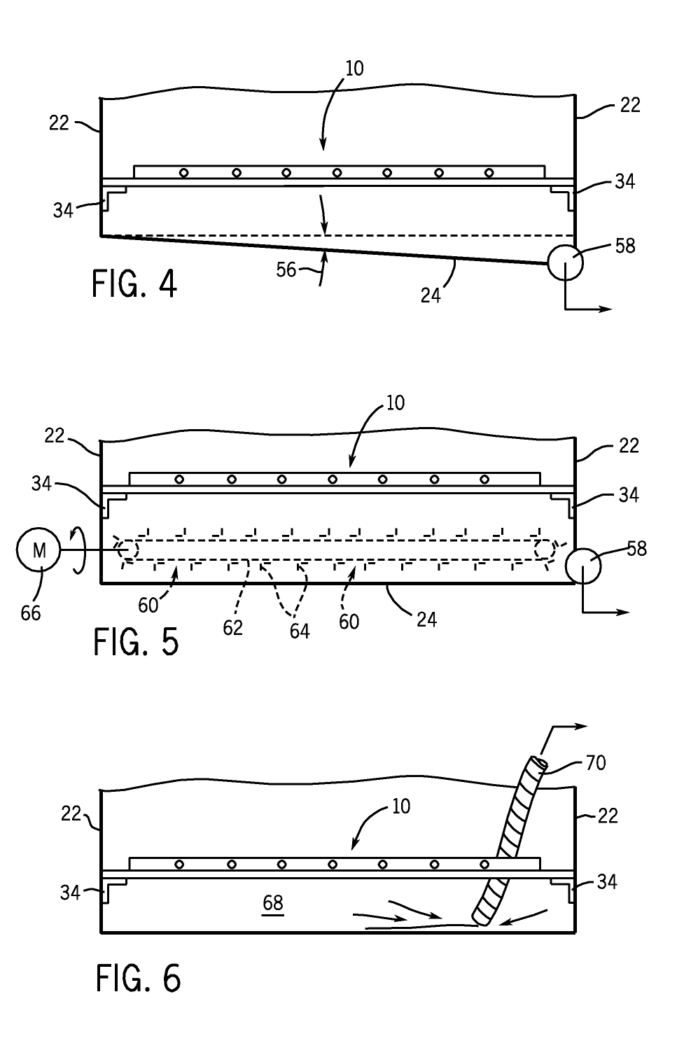

FIGS. 4, 5 and 6 illustrate exemplary embodiments for the collection and removal of silt, sludge, debris and grit in the free space below the elevated aeration system 10. In particular, in the embodiment of FIG. 4, the bottom 24 of the reactor vessel is inclined as indicated by angle 56 in the figure. Silt, sludge, debris, and grit may thus collect along the bottom of the vessel and will tend to move or flow towards a bottom edge where they can be easily collected and extracted by a screw auger 58. As will be appreciated by those skilled in the art, any suitable type of collection and removal device can be used, with a screw auger being only one exemplary device. Such devices will typically be sealed within the vessel to prevent the leakage of wastewater under treatment, and may be driven continuously or periodically by a suitable electric motor. Moreover, such removal systems may be automatically controlled or may be manually operated on an as-needed basis. Similarly, as an alternative to the angled bottom illustrated in FIG. 4, the bottom on the vessel may be inclined towards a central point or line, such that silt, sludge, debris, and grit will tend to collect at one points or along a line for removal by automated or manual means.

In the embodiment illustrated in FIG. 5, a scraper system 60 is provided in the free space below the elevated aeration system 10. In this embodiment, the scraper system 10 includes a continuous chain 62 that can move around end rollers supported near the sides of the vessel. Scrapers 64 are provided on the chain that can move any silt, sludge, debris, and grit along the bottom of the vessel towards a removal device, such as a screw auger 58. Here again, the screw auger may operated by a suitable electric motor, and may be automatically or manually engaged. The scraper system itself may be operated by another motor as indicated by reference numeral 66, which may be disposed inside or outside of the reactor vessel.

Still further, any silt, sludge, debris, and grit that collects below the elevated aeration system 10 may be removed on a periodic basis by vacuum means. FIG. 6 illustrates this type of embodiment, in which the free space 68 below the elevated aeration system is completely unencumbered. A vacuum removal system, represented generally by reference numeral 70, may be dropped into the reactor vessel from time to time and urged toward the bottom of the vessel. From this location, the vacuum removal system may collect the silt, sludge, debris and grit that will have settled to the bottom of the vessel. Various heads, attachments, screens and so forth may be provided on the vacuum removal system so as to limit any tendency to draw the biological growth support media in the vacuum system.

It should be noted that certain embodiments of the elevated aeration system described above may be more advantageous for certain types and designs of systems. For example, mechanisms for elevating aeration systems that include supports extending from walls of a reactor vessel may be best used in smaller vessels where the spans between side walls are sufficiently short to permit reasonably sized support structures for the air conduits. In a presently contemplated embodiment, for example, such elevated aeration systems may be used with reactor vessels of the type described in U.S. provisional patent application Ser. No. 61/154,211, filed on Feb. 20, 2009, entitled Modular Wastewater Treatment System and Method, which is hereby incorporated herein by reference.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A wastewater treatment reactor comprising:
side walls and a floor joined to enclose an interior volume in which wastewater is received;
an aeration system elevated from the floor on one or more supports that are not in contact with the floor, the aeration system including a conduit for receiving air and expelling air into wastewater within the reactor.

2. The wastewater treatment reactor of claim 1, wherein the supports extend from the side walls.

3. The wastewater treatment reactor of claim 1, wherein the aeration system included longitudinal support members secured to the supports.

4. The wastewater treatment reactor of claim 3, wherein the aeration system includes a header and a plurality of distribution conduits extending from the header, the header receiving air and communicating the air to the distribution conduits from which air is expelled into the wastewater within the reactor.

5. The wastewater treatment reactor of claim 1, wherein the aeration system rests on the supports.

6. The wastewater treatment reactor of claim 1, wherein the aeration system is hung from the supports.

7. The wastewater treatment reactor of claim 1, comprising means for conveying debris from a space between the aeration system and the floor of the reactor.

8. The wastewater treatment reactor of claim 7, wherein the means for conveying debris includes a screw auger.

9. The wastewater treatment reactor of claim 8, wherein the floor of the reactor is inclined towards the screw auger.

10. The wastewater treatment reactor of claim 7, wherein the means for conveying debris includes a continuous chain conveyor.

11. A wastewater treatment reactor comprising:
side walls and a floor joined to enclose an interior volume in which wastewater is received;
a plurality of supports, none of the supports being disposed in a central area of the floor; and
an aeration system elevated from the floor on the supports.

12. The wastewater treatment reactor of claim 11, wherein the supports extend from the side walls.

13. The wastewater treatment reactor of claim 11, wherein the aeration system included longitudinal support members secured to the supports.

14. The wastewater treatment reactor of claim 13, wherein the aeration system includes a header and a plurality of distribution conduits extending from the header, the header receiving air and communicating the air to the distribution conduits from which air is expelled into the wastewater within the reactor.

15. The wastewater treatment reactor of claim 11, wherein the aeration system rests on the supports.

16. The wastewater treatment reactor of claim 11, wherein the aeration system is hung from the supports.

17. A wastewater treatment reactor comprising:
side walls and a floor joined to enclose an interior volume in which wastewater is received;
a plurality of supports extending from the side walls; and
an aeration system elevated from the floor on the supports and including a conduit for receiving air and expelling air into wastewater within the reactor.

18. The wastewater treatment reactor of claim 17, wherein the aeration system included longitudinal support members secured to the supports.

19. The wastewater treatment reactor of claim 18, wherein the aeration system includes a header and a plurality of distribution conduits extending from the header, the header receiving air and communicating the air to the distribution conduits from which air is expelled into the wastewater within the reactor.

20. The wastewater treatment reactor of claim 19, comprising means for conveying debris from a space between the aeration system and the floor of the reactor.

21. A method for removing debris from a wastewater treatment reactor, the method comprising:
supporting an aeration system above a floor of the reactor via a plurality of supports, with no support being disposed on the floor of the reactor; and
removing debris from the floor of the reactor without displacing the aeration system.

22. The method of claim 21, wherein the aeration system is supported on brackets extending from walls of the reactor.

23. The method of claim 21, wherein the debris is removed by a mechanical removal device disposed in a space between the aeration system and the floor of the reactor.
